(19) United States
(12) Patent Application Publication
(10) Pub. No.: US 2014/0040218 A1
(43) Pub. Date: Feb. 6, 2014

(54) METHODS AND SYSTEMS FOR AN INTENT LOCK ENGINE

(71) Applicants: Hideaki KIMURA, Providence, RI (US); Geotz Graefe, Madison, WI (US); Harumi Kuno, Cupertino, CA (US)

(72) Inventors: Hideaki KIMURA, Providence, RI (US); Geotz Graefe, Madison, WI (US); Harumi Kuno, Cupertino, CA (US)

(21) Appl. No.: 13/563,609

(22) Filed: Jul. 31, 2012

(51) Int. Cl. G06F 17/30

(52) U.S. Cl. CPC G06F 17/30371
USPC 707/704

(57) ABSTRACT

In at least some examples, a system may include a processor core and a non-transitory computer-readable memory in communication with the processor core. The non-transitory computer-readable memory may store an intent lock engine to manage intent locks based on a private lock table for each process associated with said processor core and a global lock table for a plurality of processes associated with at least one of a plurality of processor cores including said processor core.

### BACKGROUND

Traditional database systems are driven by the assumption that disk I/O is the primary bottleneck, overshadowing all other costs. However, future database systems may involve many-core processors, large main memory, and low-latency semiconductor mass storage. In the increasingly common case that the working data set fits in memory or low-latency storage, new bottlenecks may emerge: locking, latching, logging, and critical sections in the buffer manager.

### BRIEF DESCRIPTION OF THE DRAWINGS

For a detailed description of various examples, reference will now be made to the accompanying drawings in which:

FIG. 1 shows a system in accordance with an example;

FIG. 2A shows a multi-core processor in accordance with an example;

FIG. 2B shows a multi-processor node in accordance with an example;

FIG. 3 shows a multi-node system in accordance with an example;

FIG. 4 shows an intent lock engine in accordance with an example;

FIG. 5 shows a method in accordance with an example; and

FIG. 6 shows components of a computer system in accordance with an example.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection.

### DETAILED DESCRIPTION

The following discussion is directed to methods and systems for handling locking in a database system. The disclosed techniques are intended for modern hardware and address various database locking issues including key range locking and intent locks. These techniques are applicable to various database systems. Experiments with Shore-MT, a transaction processing engine used as the implementation basis, show throughput improvement by factors of 5 to 50.

It should be noted that the examples given herein should not be interpreted, or otherwise used, as limiting the scope of the disclosure, including the claims. In addition, one skilled in the art will understand that the following description has broad application, and the discussion of any particular example is not intended to intimate that the scope of the disclosure, including the claims, is limited to that example.

The disclosed intent lock engine for handling database locking issues may be implemented by software executed by hardware, by programmable hardware, and/or by application specific integrated circuits (ASICs). In accordance with disclosed examples, the disclosed intent lock engine operations are intended for modern hardware. In contrast, legacy database systems are intended to balance CPU operations against the bottleneck of disk I/O. However, databases on modern hardware may be based on an architecture dominated by many core processors, large main memory, and low-latency semiconductor mass storage, and thus face different bottlenecks. The disclosed control mechanism for intent locks focuses on shortening code paths and on reducing the potential for contention.

Locking is a mechanism to separate concurrent transactions. A suitable locking scheme is shown in Table 1, where share (S) mode is distinguished from exclusive (X) mode (N refers to no-lock).

TABLE 1

| | N | S | X |
|---|---|---|---|
| N | Yes | Yes | Yes |
| S | Yes | Yes | No |
| X | Yes | No | No |

As shown in Table 1, S-locks are compatible with each other while X-locks are exclusive.

Serializable transaction isolation protects not only existing records and key values but also non-existing ones. For example, after a query such as “Select count(*) From T Where T.a=15” has returned a count of zero, the same query within the same transaction must return the same count. In other words, the absence of key value 15 must be locked for the duration of the transaction. Key range locking achieves this with a lock on a neighboring existing key value in a mode that protects not only the existing record but also the gap between two key values.

In at least some examples, the disclosed intent lock engine uses a key range locking protocol that ensures maximal concurrency for serializable transactions. Without limitation to other examples, the disclosed intent lock engine may apply the theory of multi-granularity and hierarchical locking to keys and gaps in B-tree leaves. Further, fence keys and ghost (pseudo-deleted) records may be exploited and can be locked as needed.

Fence keys are keys that define the lowest and highest keys that can exist in a node. Fence keys enable efficient key range locking, as well as the inexpensive and continuous, yet comprehensive, verification of the B-tree structure and all its invariants.

Meanwhile, ghost records are a technique used in many B-tree implementations, by which a user transaction that requests a deletion marks the deleted record invalid by flipping a “ghost bit” instead of actually erasing it. Ghost records do not contribute to query results, but the key of a ghost record does participate in concurrency control and key range locking just as the key of a valid record would.

For at least some examples of the disclosed intent lock engine, a locking protocol that provides specific locking instructions for cursors is used. More specifically, the disclosed intent lock engine manages the end points of inclusive and exclusive, ascending and descending cursors.

ARIES/KVL refers to a locking protocol to ensure serializability by locking neighboring keys. In addition to the newly inserted key, it locks the next key until the new key is inserted and locked. Meanwhile, ARIES/IM refers to a locking protocol that reduces the number of locks for tables with multiple secondary indexes. However, in some cases, these designs unnecessarily reduce concurrency, because they do not differentiate locks on keys from locks on ranges between keys.

Various key range lock modes are possible for the disclosed intent lock engine. For example, a set of key range lock modes implemented in a Microsoft SQL Server may be suitable. In this design, there is a separation between key and range. Further, a lock mode can have two parts—range mode and key mode. The key mode protects an existing key value while the range mode protects the range down to the previous key (aka “next-key locking”). For example, the “RangeX-S” lock protects a range in exclusive mode and a key with share mode. Compatibility of key mode and lock mode is orthogonal. Two locks are compatible if and only if both key modes and both range modes are compatible, respectively.

However, if a key range lock mechanism treats key and range not completely orthogonally, the design is sometimes too conservative. For example, a “RangeS-N” mode may be lacking (where N stands for “not locked”), which would be a useful lock to protect the absence of a key value. Further, a “RangeS-X” mode and/or a “RangeX-N” mode may be lacking. For example, suppose an index on column T.a has keys 10, 20, and 30. One transaction issues “Select*From T Where T.a=15”, which leaves a “RangeSS” lock on key value 20. When another transaction issues “Update T Set b=1, Where T.a=20”, its lock request conflicts with the previous lock although these transactions really lock different things and actually do not violate serializability.

There is another comprehensive and orthogonal set of key range lock modes that enable simplicity as well as concurrency. This set of key range lock modes combines them with fence keys, ghost records, and system transactions, and thus permits a first empirical evaluation and comparison of the design. In at least some examples, the disclosed intent lock engine implements a comprehensive and orthogonal set of key range lock modes.

In a Data-Oriented execution (DORA) approach, physical lock contentions are eliminated by assigning threads for logical partition of data. The approach is analogous to PLP for latching. The tie between execution model and the locking protocol has some assumptions and limitations. Also, the work is orthogonal to concurrency of lock modes because they eliminate only physical lock contentions, not logical contentions (logical concurrency).

Table 2 shows a list of key range lock modes supported by the disclosed intent lock engine in accordance with examples of the disclosure.

TABLE 2

| | N | S | X | NS | NX | SN | SX | XN | XS |
|---|---|---|---|---|---|---|---|---|---|
| N | Yes | Yes | Yes | Yes | Yes | Yes | Yes | Yes | Yes |
| S | Yes | Yes | No | Yes | No | Yes | No | No | No |
| X | Yes | No | No | No | No | No | No | No | No |
| NS | Yes | Yes | No | Yes | No | Yes | No | Yes | Yes |
| NX | Yes | No | No | No | No | Yes | No | Yes | No |
| SN | Yes | Yes | No | Yes | Yes | Yes | Yes | No | No |
| SX | Yes | No | No | No | No | Yes | No | No | No |
| XN | Yes | No | No | Yes | Yes | No | No | No | No |
| XS | Yes | No | No | Yes | No | No | No | No | No |

In Table 2, the key range lock modes may protect half-open intervals [A,B). For example, ‘SX’ mode (pronounced “key shared, gap exclusive”) protects the key A in shared mode and the open interval (A,B) in exclusive mode. S is a synonym for SS, X for XX.

However, using these locks, locks on key values and gaps are orthogonal. In the example above, the first transaction and its query “Select*From T Where T.a=15” can lock key value 10 (using prior-key locking) in “NS”-mode (key free, gap shared). Another transaction's concurrent “Update T Set b=1 Where T.a=10” can lock the same key value 10 in “XN”-mode (key exclusive, gap free). In some cases, a lock in RangeS-S mode is taken and thus have lower concurrency than the disclosed NS-lock, which allows concurrent updates on neighboring keys because NS and XN are compatible.

When a query searches for a non-existing key that sorts below the lowest key value in a leaf page but above the separator key in the parent page, a “NS”-lock on the low fence key in the leaf is used. Since the low fence key in a leaf page is equal to the high fence key in the next leaf page to the left, key range locking works across leaf page boundaries.

Point queries: Algorithms 1 and 2 show the pseudo code for INSERT and SELECT queries (UPDATE and DELETE are omitted for convenience).

```
Algorithm 1: INSERT locking protocol
Data: B: B-tree index, L: Lock table
Input: key: Inserted key
leaf page = B.Traverse(key); // hold latch*
slot = leaf page.Find(key);
if slot.key == key then //Exact match
  L.Request-Lock(key, XN);
  if slot is not ghost then
    return (Error: DUPLICATE);
    leaf page.Replace-Ghost(key);
else //Non-existent key. In this case, slot is the previous key
  if slot < 0 then //hits left boundary of the page
    L.Check-Lock(leaf page.low fence key, NX);
  else
    L.Check-Lock(slot.key, NX);
  begin System-Transaction
    leaf page.Create-Ghost(key);
  L.Request-Lock(key, XN);//lock the ghost
  leaf page.Replace-Ghost(key);
* To reduce the time latches are held, all lock requests are
conditional. If denied, immediately give up and release latches,
then lock unconditionally followed by a page LSN check.
Algorithm 2: SELECT locking protocol
Data: B: B-tree index, L: Lock table
Input: key: Searched key
leaf page = B.Traverse(key); // hold S latch
slot = leaf page.Find(key);
if slot.key == key then //Exact match
  L.Request-Lock(key, SN);
  if slot is not ghost then
    return (slot.data);
  else
    return (Error: NOT-FOUND);
else //Non-existent key
  if slot < 0 then //hits left boundary of the page
    L.Request-Lock(leaf page.low fence key, NS);
  else
    L.Request-Lock(slot.key, NS);
  return (Error: NOT-FOUND);
```

In at least some examples, the disclosed intent lock first checks if the corresponding leaf page has the key being searched for. If so, a key-only lock mode such as SN and XN suffices. This is true even if the existing record is a ghost record. Furthermore, the existing ghost record speeds up insertion, which only has to turn it into a non-ghost record (toggling the record's ghost bit and overwriting non-key data).

The design uses system transactions for creating new ghost records as well as all other physical creation and removal operations. User transactions only update existing records, toggling their ghost bits as appropriate. Because a system transaction does not modify the database's logical content, it does not have to take locks, flush its log at the commit time, or undo its effects if the involving user transaction rolls back. This separation greatly simplifies and speeds up internal code paths.

To ensure serializability, traditional designs without fence records sometimes lock key values in neighboring pages. In contrast, by exploiting fence keys are lockable key values, the disclosed design and implementation takes locks only on keys within the current page, simplifying and speeding up the locking protocol.

Range queries such as “Select*From T Where T.a Between 15 And 25” need cursors protected by lock modes as shown in Table 3. The lock mode to take depends on the type of cursors (ascending or descending) and on the inclusion or exclusion of boundary values in the query predicate (e.g., key >15 or key_{—}15). When a cursor initially locates its starting position, it either takes a lock on the existing key (exact match), or the previous key (non-existent) or the low fence key of the page). Then, as it moves to next key or next page, it also takes a lock on the next key (including fence keys).

Because a cursor takes a lock for each key, the overhead to access the lock table is relatively high. This is the reason why the locks marked with (*) in Table 3 are more conservative than necessary. For example, an ascending cursor starting from exact-match on A could take only an “SN” lock on A and then upgrade to an “S” lock on the same key when moving on to the next key. However, this doubles the overhead to access the lock table. Accordingly, in at least some examples, the disclosed intent lock engine takes the two locks at the same time to reduce the overhead at the cost of slightly lower concurrency, which is the same trade-off as the coarse-grained lock herein.

TABLE 3

| Cursor type | |
|---|---|
| Ascending | Descending |

| Boundary type | Incl. | Excl. | Incl. | Excl. |
|---|---|---|---|---|
| Initial (exact match) | S* | NS | SN* | N |
| Initial (non-exact | NS | NS | S | S |
| match) | | | | |
| Initial (non-exact | NS | NS | NS | NS |
| match; fence low) | | | | |

| | | |
|---|---|---|
| Next; page-move | S (SN if last) | S (NS if last) |

The record-level locking techniques discussed herein provide granular locks that guarantee correctness with maximal concurrency. However, record-level locks might cause an unacceptable overhead for a transaction that reads or writes a large number of records. Hence, most database management systems (DBMSs) also provide coarse-grained intent locks in order to support both coarse and fine-grained locks on the same data. However, intent locks may become a source of physical contention as a large number of concurrent threads simultaneously acquire and release them. Accordingly, the disclosed intent lock engine implements a simpler, faster, and more scalable implementation of intent locks for modern hardware.

TABLE 4

| | N | S | X | IS | IX | SIX |
|---|---|---|---|---|---|---|
| N | Yes | Yes | Yes | Yes | Yes | Yes |
| S | Yes | Yes | No | Yes | No | No |
| X | Yes | No | No | No | No | No |
| IS | Yes | No | No | Yes | Yes | Yes |
| IX | Yes | Yes | No | Yes | Yes | No |
| SIX | Yes | No | No | Yes | No | No |

Table 4 shows various coarse locks that may be handled by the disclosed intent lock engine. In at least some examples, a transaction takes an IS or IX lock on a high-level object (e.g., Index) in addition to record-level locks. These intent locks are compatible each other. On the other hand, absolute locks such as S, X and SIX (S+IX) on higher levels are taken by table scan or lock escalation, which conflict with all the other transactions. Intent locks allow scanning and bulk-modification transactions to protect their accesses with only a single lock, dramatically reducing overhead compared to taking potentially millions of record-level locks. With the exception of absolute locks, intent locks are compatible and cause no logical contention.

However, each transaction must create a lock request for intent locks in the lock table and then remove it when it commits. Further, because intent locks are coarse locks, a large number of transactions will take intent locks on the same object (e.g., disk volume intent lock). This causes physical contention on the lock bucket because all operations in a lock bucket are synchronized by mutexes.

The physical contention on intent locks causes a significant bottleneck on many-core architectures where tens or hundreds of concurrent threads might be racing on the same intent lock. A technique referred to as Speculative Lock Inheritance (SLI) is able to eliminate the contention by allowing a transaction to inherit intent locks from the previous transaction on the same thread, bypassing both the acquisition and release of intent locks.

Even in the SLI scheme, all transactions must release intent locks upon absolute lock requests because otherwise absolute locks would never be granted. In other words, a single lock escalation flushes out all inherited intent locks. All concurrent threads then must reacquire intent locks, again causing physical contention. In accordance with at least some examples, the disclosed intent lock engine manages the issues of inefficiency and low scalability for intent locks. Instead of working around it by inheriting locks, the disclosed intent lock engine operates to improve the performance of intent locks.

To address the above issues, the disclosed intent lock engine implements a simpler and faster intent lock scheme designed for modern hardware. In at least some examples, the disclosed intent lock engine implements a set of counters, instead of lock queues, that is separate from the main lock table. In the disclosed intent lock engine, mutexes are used only when an absolute lock is requested.

The operations of the disclosed intent lock engine are based on the observation that intent locks have a limited number of lock modes and infrequent logical contention. Therefore, a simpler method is more appropriate than the heavyweight mutexes, lock queues and point-to-point communications used in the main lock table for non-intent locks.

In accordance with some examples, the disclosed intent lock engine maintains a private lock table (PLT) for each transaction (or process) in addition to a single global lock table (GLT) shared by all transactions. The PLT records intent locks obtained by the transaction. As the PLT has per-transaction data, the transaction can efficiently access its own PLT without synchronization. The GLT records the count of granted lock requests for each lock mode (e.g., S/X/IS/IX). The GLT has no lock queues, thus the only inter-thread communication is a broadcast. Algorithms 3 and 4 show the pseudo code for lock acquisition and release implemented by an example of the disclosed intent lock engine.

```
Algorithm 3: Lightweight Intent Lock: Request-Lock
Data: G: Global lock table, P: Private lock table
Input: i: Index to lock, m: lock mode (IS/IX/S/X)
  if P[i]:granted[m] is already true then
    return;
while Until timeout do
  begin Critical-SectionfG[i]:spinlockg
    if m can be granted(_) in G[i] then
      ++G[i]:granted counts[m];
      P[i]:granted[m] = true;
      return;
    if m 2 fS;Xg then
      Leave a flag to announce absolute locks*;
    base version = G[i]:version;
  cur version = base version;
  while cur version == base version do
    Conditional-Wait(G[i].mutex, 1 millisec);
    cur version = G[i]:version;
* To not starve absolute locks, the count of waiting locks for each
lock mode is maintained and give absolute locks higher priority.
For example, IX locks are not granted while S lock request is
waiting.
Algorithm 4: Lightweight Intent Lock: Release-Lock
Data: G: Global lock table, P: Private lock table
Input: i: Index to release
if P[i]:granted[m] are all false then
  return;
begin Critical-SectionfG[i]:spinlockg
  ++G[i]:version;
  foreach m do
    if P[i]:granted[m] == true then
      −−G[i]:granted counts[m];
if Released any lock that was blocking other thread then
  Broadcast(G[i].mutex);
```

In algorithm 3, when a transaction requests an intent lock, it first checks its own PLT. If it already has a granted lock that satisfies the need, it does nothing. Otherwise, it atomically checks the GLT and increments the counter for the desired lock mode. Whether the lock request is immediately granted or not, the critical section for this check is extremely short and a spinlock suffices, avoiding mutex overheads.

If the request is not immediately granted, the disclosed intent lock engine waits for the release of locks preventing this request from being granted. In accordance with at least some examples, the disclosed intent lock engine avoids a mutex lock for this situation to avoid wasting CPU cycles, but this happens only when there is an absolute lock request or this transaction is requesting an absolute lock.

In algorithm 4, the lock release reverses the locking process and atomically decrementing the counter. If other requests on the lock were waiting on the current transaction, the disclosed intent lock engine may broadcast a message to all waiting threads. As a mutex broadcast after the critical section might cause a race condition, each waiting thread wakes up after a short interval (e.g., 1 ms) and repeatedly checks the version of the lock and tries again if some transaction released a lock.

Regarding deadlocks, the disclosed intent lock engine may employ a simple timeout policy to prevent deadlocks. Waits on intent locks happen much less often than non-intent locks. In addition, the latency of scanning and bulk-modification transactions, which are the only types of transactions that could cause waits in LIL, is much higher than that of other types of transactions. Thus, delayed deadlock detection due to the timeout policy does not have a significant impact on overall performance. Hence, a transaction is simply aborted when its wait time exceeds a certain threshold. To avoid repeatedly aborting a scanning transaction, a longer timeout may be assigned for absolute lock requests.

In accordance with at least some examples, the operations of the disclosed intent lock engine cause neither deadlocks nor long waits. Therefore, the occurrence of deadlocks between locks in the intent lock engine and locks in the main lock table is avoided. In other words, the main lock table does not need to be aware of intent locks at all. Thus, the disclosed intent lock engine simplifies not only intent locks but non-intent locks and shortens their critical sections.

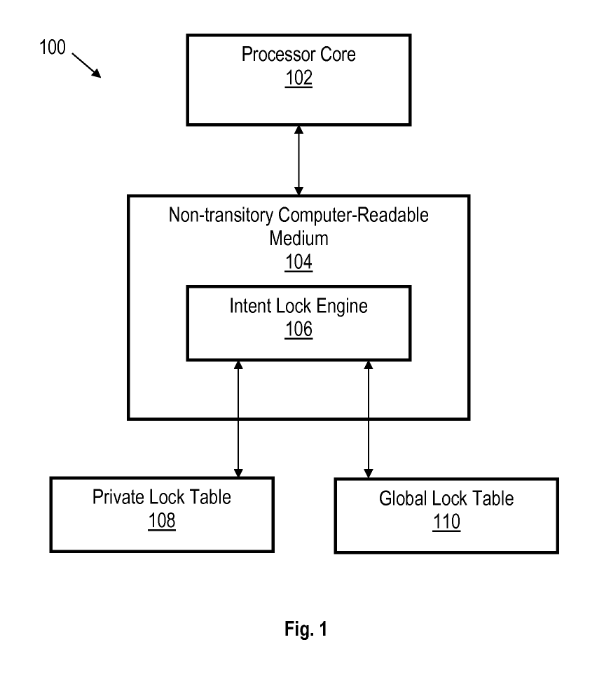

FIG. 1 shows a system 100 in accordance with an example of the disclosure. As shown, the system 100 comprises a processor core 102 in communication with a non-transitory computer-readable medium 104 storing an intent lock engine 106. When executed by the processor core 102, the intent lock engine 106 manages intent locks based on a private lock table 108 for each process or transaction being executed by the processor core 102 and a global lock table 110 for a plurality of processes or transactions being executed by at least one of a plurality of processor cores including the processor core 102. In at least some examples, the private lock table 108 and the global lock table 110 track share mode locks, share mode intent locks, exclusive mode locks, and exclusive mode intent locks.

In some implementations, upon receipt of an intent lock request, the intent lock engine 106 causes a process being executed by the processor core 102 to check the private lock table 108 for an intent lock compliant with the intent lock request before submitting the intent lock request to the global lock table 110. If the intent lock request is submitted to the global lock table 110, the intent lock engine 106 increases a counter separate from the global lock table 110 for an intent lock type associated with the intent lock request. When the intent lock request corresponds to an absolute lock, the intent lock engine 106 causes a process being executed by the processor core 102 to apply a mutex lock. Otherwise, mutex locks are not used.

When an intent lock corresponding to an intent lock request is released, the intent lock engine 106 decrements the counter separate from the global lock table 110 for an intent lock type associated with the intent lock request. Further, when an intent lock corresponding to an intent lock request is released, the intent lock engine 106 may cause a process being executed by the processor core 102 to broadcast a message to awaiting threads. In some implementations, the intent lock engine 106 causes a thread being executed by at least one of a plurality of processor cores (including the processor core 102) to wake up according to a predetermined (non-simultaneous) multi-thread schedule upon release of an intent lock.

In some implementations, the non-transitory computer-readable medium 104 storing the intent lock engine 106 is separate from the processor core 102. In alternative implementations, the non-transitory computer-readable medium 104 storing the intent lock engine 106 is integrated with the processor core 102. In some implementations, the private lock table 108 may be stored in the processor core 102 or in the non-transitory computer-readable medium 104. In alternative examples, the private lock table 108 may be stored in another data storage unit accessible to the processor core 102. Similarly, the global lock table 110 may be stored in the processor core 102 or in the non-transitory computer-readable medium 104. In alternative implementations, the global lock table 110 may be stored in another data storage unit accessible to the processor core 102.

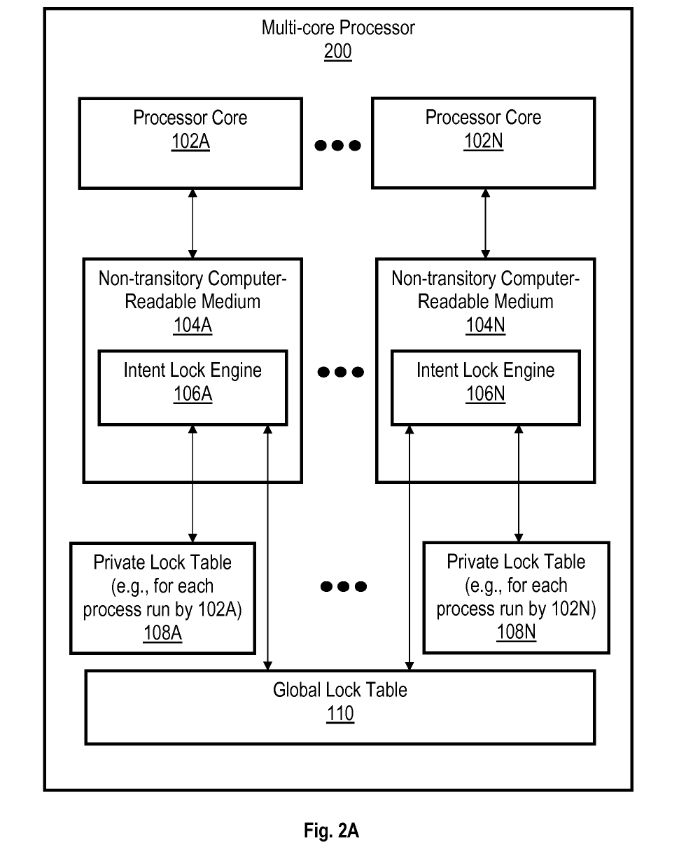

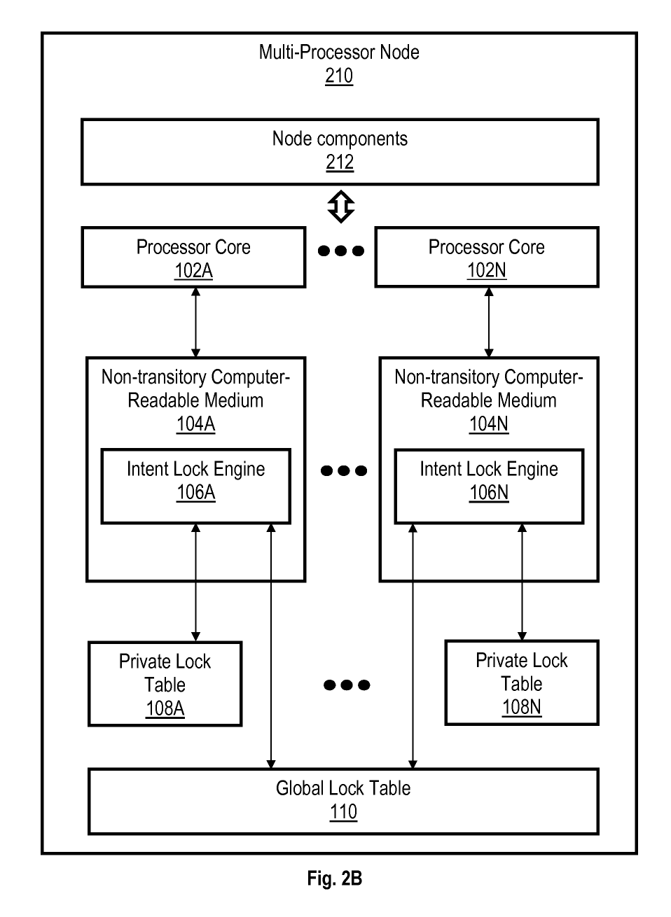

FIG. 2A shows a multi-core processor 200 in accordance with an example of the disclosure. As shown, the multi-core processor 200 may comprise a plurality of processor cores 102A-102N. Each of the processor cores 102A-102N is in communication with a non-transitory computer-readable medium 104A-104N storing a respective intent lock engine 106A-106N. In other words, each of the processor cores 102A-102N may be associated with a respective intent lock engine 106A-106N. Each of the intent lock engines 106A-106N has access to a respective private lock table 108A-108N and to the global lock table 110. Further, each of the intent lock engines 106A-106N may support the various intent lock engine operations described for the intent lock engine 106 of FIG. 1. Without limitation to other implementations, the private lock table 108A-108N and the global lock table 110 may track share mode locks, share mode intent locks, exclusive mode locks, and exclusive mode intent locks.

In some implementations, the non-transitory computer-readable mediums 104A-104N storing the respective intent lock engines 106A-106N are separate from the respective processor cores 102A-102N. In alternative implementations, the non-transitory computer-readable mediums 104A-104N storing the respective intent lock engines 106A-106N are integrated with the respective processor cores 102A-102N. Further, in some implementations, the private lock tables 108A-108N may be stored in the respective processor cores 102A-102N or in the respective non-transitory computer-readable mediums 104A-104N. In alternative implementations, the private lock tables 108A-108N may be stored in at least one data storage unit accessible to the processor cores 102A-102N. In different implementations, the private lock tables 108A-108N and/or the global lock table 110 may be stored in the multi-core processor 200 or may be external to the multi-core processor 200. Further, in different implementations, intent lock engines 106A-106N for the respective processor cores 102A-102N may be stored in the multi-core processor 200 or may be external to the multi-core processor 200.

FIG. 2B shows a multi-processor node 210 in accordance with an example of the disclosure. As shown, the multi-processor node 210 of FIG. 2B comprises the same or similar components as described for the multi-core processor 200 of FIG. 2A, and the same discussion provided for the multi-core processor components is applicable to the multi-processor node components. Also, the multi-processor node 210 may comprise node components 212 such as memory resources, input/output resources, a communication fabric, a node controller, and/or other components in communication with the processor cores 102A-102N. In different implementations, the private lock tables 108A-108N and/or the global lock table 110 may be stored in the multi-processor node 210 or may be external to the multi-processor node 210. Further, in different implementations, the intent lock engines 106A-106N for the respective processor cores 102A-102N may be stored in the multi-processor node 210 or may be external to the multi-processor node 210.

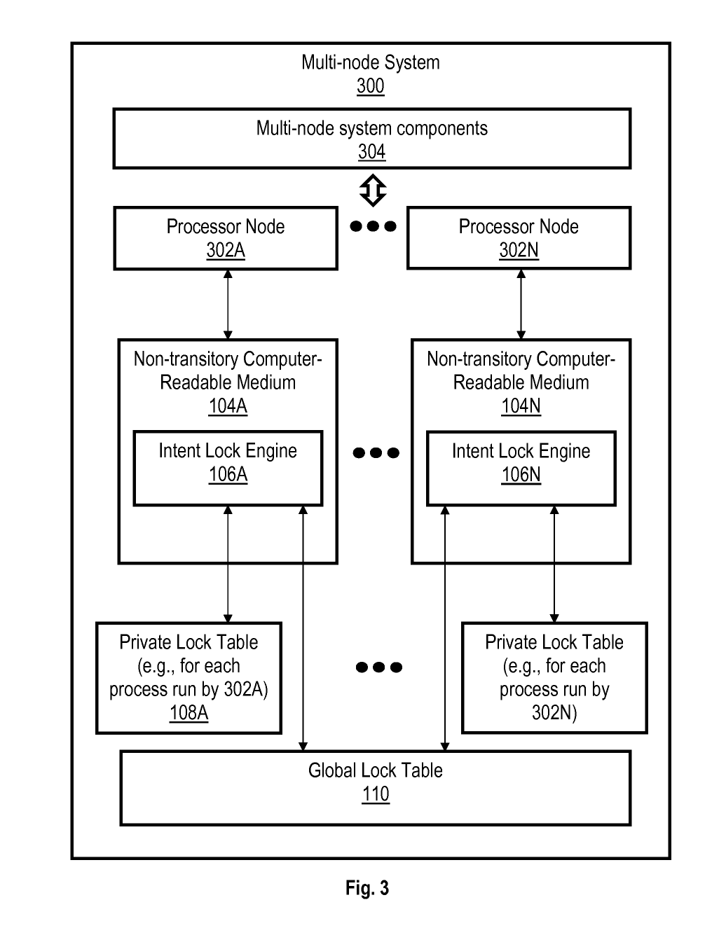

FIG. 3 shows a multi-node system 300 in accordance with an example of the disclosure. As shown, the multi-node system 300 comprises a plurality of processor nodes 302A-302N. Each of the processor nodes 302A-302N may comprise processing resources, memory resources, and I/O resources. Further, the multi-node system 300 may comprise various of the same or similar components as described for the multi-core processor 200 of FIG. 2A, and the same discussion provided for the multi-core processor components is applicable to the multi-node system components. Also, the multi-node system 300 may comprise multi-node system components 304 such as multi-node memory resources, multi-node input/output resources, a multi-node communication fabric, node controllers, and/or other components in communication with the processor nodes 302A-302N. In different implementations, the private lock tables 108A-108N and/or the global lock table 110 may be stored in the multi-node system 300 or may be external to the multi-node system 300. Further, in different implementations, intent lock engines 106A-106N for the respective processor nodes 302A-302N may be stored in the multi-node system 300 or may be external to the multi-node system 300.

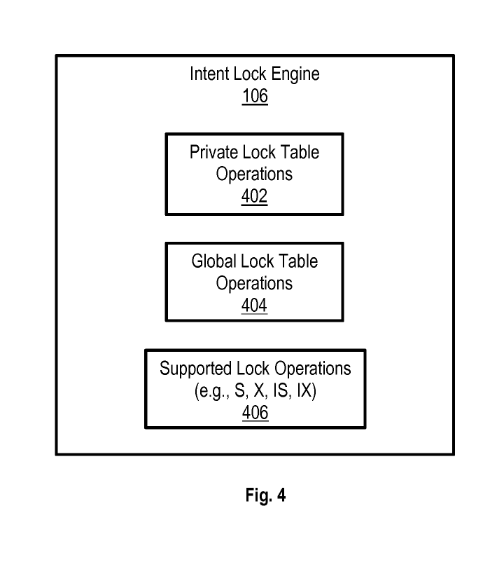

FIG. 4 shows the intent lock engine 160 in accordance with an example of the disclosure. As shown, the intent lock engine 160 comprises private lock table operations 402, global lock table operations 404, and supported lock operations 406. When executed, the private lock table operations 402 enable a processor to perform the private lock table functions described herein. As an example, a private lock table may track share mode locks, share mode intent locks, exclusive mode locks, and exclusive mode intent locks for a particular processor, transaction, or process. More specifically, upon receipt of an intent lock request, the private lock table operations 402 may cause a processor running a process to check the private lock table 108 for the process for an intent lock compliant with the intent lock request before submitting the intent lock request to the global lock table 110. If the intent lock request is submitted to the global lock table 110, the private lock table operations 402 and/or the global lock table operations 404 cause a processor core to increase a counter separate from the global lock table 110 for an intent lock type associated with the intent lock request. When the intent lock request corresponds to an absolute lock, the private lock table operations 402 and/or the global lock table operations 404 may trigger a mutex lock feature that causes a processor running a process to apply a mutex lock. Otherwise, mutex locks are not used.

When an intent lock corresponding to an intent lock request is released, the private lock table operations 402 and/or the global lock table operations 404 cause a processor to decrement a counter separate from the global lock table 110 for an intent lock type associated with the intent lock request. Further, when an intent lock corresponding to an intent lock request is released, the private lock table operations 402 and/or the global lock table operations 404 may trigger a broadcast feature that causes a processor running a process to broadcast a message to awaiting threads, which may or may not be running on the same processor. Further, in some implementations, the private lock table operations 402 and/or the global lock table operations 404 may trigger a thread wake-up feature that causes a processor running a process to wake-up a thread being run by at least one of a plurality of processor (including the processor running the process) according to a predetermined multi-thread schedule upon release of an intent lock.

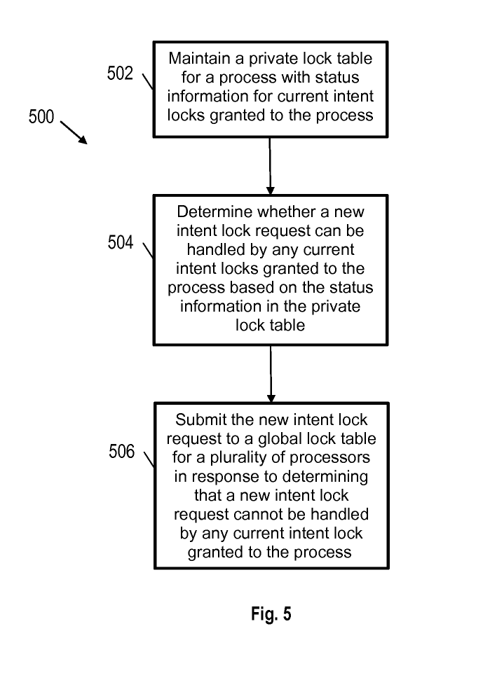

FIG. 5 shows a method 500 in accordance with an example of the disclosure. The method 500 may be performed, for example, by a processor core 102, a processor node 302, or a computer system running a process. As shown, the method 500 comprises maintaining a private lock table for the process with status information for current intent locks granted to the process at block 502. At block 504, the method 500 comprises determining whether a new intent lock request can be handled by any current intent locks granted to the process based on the status information in the private lock table. At block 506, a new intent lock request is submitted to a global lock table for a plurality of processes in response to determining that a new intent lock request cannot be handled by any current intent lock granted to the processor.

The method 500 may additionally or alternatively comprise other steps. For example, the method 500 may comprise incrementing a counter separate from a global lock table for an intent lock type associated with the new intent lock request in response to said submitting. Further, the method 500 may comprise decrementing a counter separate from a global lock table for an intent lock type associated with an intent lock request when the intent lock corresponding to the intent lock request is released. Further, the method 500 may comprise broadcasting a message to awaiting threads when an intent lock corresponding to an intent lock request is released. Further, the method 500 may comprise waking up a thread according to a predetermined (non-simultaneous) multi-thread schedule upon release of an intent lock.

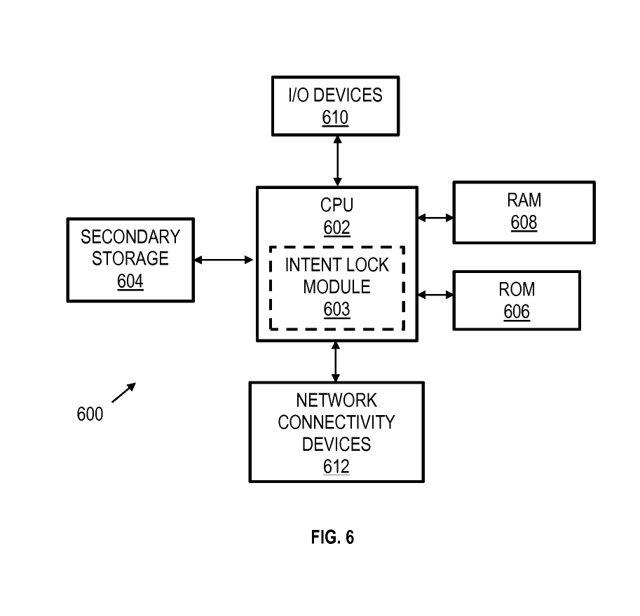

FIG. 6 shows components of a computer system 600 in accordance with an example of the disclosure. The computer system 600 may perform various operations to support the intent lock engine operations described herein. The computer system 600 may correspond to part of database system that includes the processor core 102, the multi-core processor 200A, the multi-processor node 200B, and/or the multi-node system 300 described herein.

As shown, the computer system 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips. As shown, the processor 602 comprises an intent lock module 603, which corresponds to a software implementation of the intent lock engine described herein. Alternatively, the intent lock module 603 may be stored external to the processor 602 and may be accessed as needed to perform the intent lock engine operations described herein. In some examples, the intent lock engine 106 of FIG. 1 may include the processor 602 executing the intent lock module 603.

It is understood that by programming and/or loading executable instructions onto the computer system 600, at least one of the CPU 602, the RAM 608, and the ROM 606 are changed, transforming the computer system 600 in part into a particular machine or apparatus having the novel functionality taught by the present disclosure. In the electrical engineering and software engineering arts that functionality that can be implemented by loading executable software into a computer can be converted to a hardware implementation by well-known design rules. Decisions between implementing a concept in software versus hardware may hinge on considerations of stability of the design and numbers of units to be produced rather than any issues involved in translating from the software domain to the hardware domain. For example, a design that is still subject to frequent change may be implemented in software, because re-spinning a hardware implementation is more expensive than re-spinning a software design. Meanwhile, a design that is stable that will be produced in large volume may be preferred to be implemented in hardware, for example in an application specific integrated circuit (ASIC), because for large production runs the hardware implementation may be less expensive than the software implementation. Thus, a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 604 is typically comprised of one or more disk drives or tape drives and is used for non-volatile storage of data and as an over-flow data storage device if RAM 608 is not large enough to hold all working data. Secondary storage 604 may be used to store programs which are loaded into RAM 608 when such programs are selected for execution. The ROM 606 is used to store instructions and perhaps data which are read during program execution. ROM 606 is a non-volatile memory device which typically has a small memory capacity relative to the larger memory capacity of secondary storage 604. The RAM 608 is used to store volatile data and perhaps to store instructions. Access to both ROM 606 and RAM 608 is typically faster than to secondary storage 604. The secondary storage 604, the RAM 608, and/or the ROM 606 may be referred to in some contexts as computer readable storage media and/or non-transitory computer readable media.

I/O devices 610 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 612 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 612 may enable the processor 602 to communicate with the Internet or one or more intranets. With such a network connection, it is contemplated that the processor 602 might receive information from the network, or might output information to the network in the course of performing the above-described method steps. Such information, which is often represented as a sequence of instructions to be executed using processor 602, may be received from and outputted to the network, for example, in the form of a computer data signal embodied in a carrier wave.

Such information, which may include data or instructions to be executed using processor 602 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 602 executes instructions, codes, computer programs, scripts which it accesses from hard disk, floppy disk, optical disk (these various disk based systems may all be considered secondary storage 604), ROM 606, RAM 608, or the network connectivity devices 612. While only one processor 602 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 604, for example, hard drives, floppy disks, optical disks, and/or other device, the ROM 606, and/or the RAM 608 may be referred to in some contexts as non-transitory instructions and/or non-transitory information.

In an example, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an implementation, virtualization software may be employed by the computer system 600 to provide the functionality of a number of servers that is not directly bound to the number of computers in the computer system 600. For example, virtualization software may provide twenty virtual servers on four physical computers. In an implementation, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an implementation, some or all of the intent lock engine functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 604, to the ROM 606, to the RAM 608, and/or to other non-volatile memory and volatile memory of the computer system 600. The processor 602 may process the executable instructions and/or data structures in part by directly accessing the computer program product, for example by reading from a CD-ROM disk inserted into a disk drive peripheral of the computer system 600. Alternatively, the processor 602 may process the executable instructions and/or data structures by remotely accessing the computer program product, for example by downloading the executable instructions and/or data structures from a remote server through the network connectivity devices 612. The computer program product may comprise instructions that promote the loading and/or copying of data, data structures, files, and/or executable instructions to the secondary storage 604, to the ROM 606, to the RAM 608, and/or to other non-volatile memory and volatile memory of the computer system 600.

In some contexts, the secondary storage 604, the ROM 606, and the RAM 608 may be referred to as a non-transitory computer readable medium or a computer readable storage media. A dynamic RAM example of the RAM 608, likewise, may be referred to as a non-transitory computer readable medium in that while the dynamic RAM receives electrical power and is operated in accordance with its design, for example during a period of time during which the computer 600 is turned on and operational, the dynamic RAM stores information that is written to it. Similarly, the processor 602 may comprise an internal RAM, an internal ROM, a cache memory, and/or other internal non-transitory storage blocks, sections, or components that may be referred to in some contexts as non-transitory computer readable media or computer readable storage media.

Such a non-transitory computer-readable storage medium may store an intent lock management program that performs the operations described herein for the intent lock engine 106. For example, the intent lock management program, when executed, may cause a processor (e.g., processor 602) running a process to maintain a private lock table for the process with status information for intent locks granted to the process. In response to initiation of an intent lock request, the intent lock management program, when executed, may cause the processor 602 to the check the status information for any intent locks in the maintained private lock table. In response to detecting that no intent locks in the maintained private lock table correspond to the intent lock request, the intent lock management program, when executed, may cause the processor 602 running the process to submit the intent lock request to a global lock table for a plurality of processes (which may running on the processor 602 and/or other processors). Without limitation to other examples, the intent lock management program, when executed, may cause the processor 602 running the process to maintain share mode locks, share mode intent locks, exclusive mode locks, and exclusive mode intent locks for the private lock table and the global lock table.

In at least some examples, the intent lock management program, when executed, further causes the processor 602 running the process to increase a counter separate from the global lock table for an intent lock type associated with the intent lock request. Further, the intent lock management program, when executed, may cause the processor 602 running the process to apply a mutex lock when the intent lock request corresponds to an absolute lock. Mutex locks may be applied to absolute locks, but not other locks. Further, the intent lock management program, when executed, may cause the processor 602 running the process to decrement a counter separate from the global lock table for an intent lock type associated with the intent lock request when the intent lock request is released. Further, the intent lock management program, when executed, may cause the processor 602 running the process to broadcast a message to awaiting threads when the intent lock corresponding to the intent lock request is released. Further, the intent lock management program, when executed, may cause the processor 602 running the process to wake up a thread according to a multi-thread schedule upon release of an intent lock.

The above discussion is meant to be illustrative of the principles and various examples of the present invention. Numerous variations and modifications will become apparent to those skilled in the art once the above disclosure is fully appreciated. It is intended that the following claims be interpreted to embrace all such variations and modifications.

1. A system, comprising:
a processor core; and
a non-transitory computer-readable memory in communication with the processor core and storing an intent lock engine to manage intent locks based on a private lock table for each process associated with said processor core and a global lock table for a plurality of processes associated with at least one of a plurality of processor cores including said processor core.

2. The system of claim 1, wherein upon receipt of an intent lock request, the intent lock engine causes a process associated with said processor core to check its private lock table for an intent lock compliant with the intent lock request before submitting the intent lock request to the global lock table.

3. The system of claim 2, wherein the intent lock engine, when the intent lock request is submitted to the global lock table, increments a counter separate from the global lock table for an intent lock type associated with the intent lock request.

4. The system of claim 1, wherein the private lock table and the global lock table track share mode locks, share mode intent locks, exclusive mode locks, and exclusive mode intent locks.

5. The system of claim 1, wherein the intent lock engine causes a process associated with the processor core to apply a mutex lock when the intent lock request corresponds to an absolute lock.

6. The system of claim 1, wherein the intent lock engine, when an intent lock corresponding to the intent lock request is released, decrements a counter separate from the global lock table for an intent lock type associated with the intent lock request.

7. The system of claim 6, wherein the intent lock engine causes a process associated with the processor core to broadcast a message to awaiting threads when the intent lock corresponding to the intent lock request is released.

8. The system of claim 1, wherein the intent lock engine causes a thread associated with at least one of the plurality of processor cores to wake up according to a predetermined multi-thread schedule upon release of an intent lock.

9. A non-transitory computer-readable medium storing an intent lock management program that, when executed, causes a processor running a process to:
maintain a private lock table for the process with status information for intent locks granted to the process;
in response to initiation of an intent lock request, check the status information for any intent locks in the maintained private lock table; and
in response to detecting that no intent locks in the maintained private lock table correspond to the intent lock request, submit the intent lock request to a global lock table for a plurality of processes associated with at least one of a plurality of processor cores including said processor core.

10. The non-transitory computer-readable medium of claim 9, wherein the intent lock management program, when executed, further causes the processor running the process to increase a counter separate from the global lock table for an intent lock type associated with the intent lock request.

11. The non-transitory computer-readable medium of claim 9, wherein the intent lock management program, when executed, further causes the processor running the process to maintain share mode locks, share mode intent locks, exclusive mode locks, and exclusive mode intent locks for the private lock table and the global lock table.

12. The non-transitory computer-readable medium of claim 9, wherein the intent lock management program, when executed, further causes the processor running the process to apply a mutex lock when the intent lock request corresponds to an absolute lock.

13. The non-transitory computer-readable medium of claim 9, wherein the intent lock management program, when executed, further causes the processor running the process to decrement a counter separate from the global lock table for an intent lock type associated with the intent lock request when the intent lock request is released.

14. The non-transitory computer-readable medium of claim 9, wherein the intent lock management program, when executed, further causes the processor running the process to broadcast a message to awaiting threads when the intent lock corresponding to the intent lock request is released.

15. The non-transitory computer-readable medium of claim 9, wherein the intent lock management program, when executed, further causes the processor running the process to wake up a thread according to a predetermined multi-thread schedule upon release of an intent lock.

16. A method, comprising:
maintaining, by a processor running a process, a private lock table for the process with status information for current intent locks granted to the process;
determining, by the processor running the process, whether a new intent lock request can be handled by any current intent locks granted to the process based on the status information in the private lock table; and
submitting, by the processor running the process, the new intent lock request to a global lock table for a plurality of processes in response to determining that a new intent lock request cannot be handled by any current intent lock granted to the process.

17. The method of claim 16 further comprising increasing a counter separate from the global lock table for an intent lock type associated with the new intent lock request in response to said submitting.

18. The method of claim 16, further comprising decrementing a counter separate from the global lock table for an intent lock type associated with the intent lock request when an intent lock corresponding to the intent lock request is released.

19. The method of claim 16, further comprising broadcasting a message to awaiting threads when the intent lock corresponding to the intent lock request is released.

20. The method of claim 16, further comprising waking up a thread according to a predetermined multi-thread schedule upon release of an intent lock.
